(19) United States
(12) Patent Application Publication
(10) Pub. No.: US 2006/0212711 A1
(43) Pub. Date: Sep. 21, 2006

(54) Communication device and communication method

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/353,831

(22) Filed: Feb. 13, 2006

(30) Foreign Application Priority Data
Mar. 17, 2005 (JP) 2005-077589

(51) Int. Cl. H04L 9/00

(52) U.S. Cl. 713/178

(57) ABSTRACT

A time stamp range designating unit is provided in a communication device, such as, for example, an Internet facsimile machine. A range for acquiring time stamp data is designated for an electronic file, and acquired time stamp data and the electronic file are associated by using an ID. The electronic file is transmitted to a remote device. After the electronic file has been edited by the remote device and returned, the time stamp data is acquired from the ID and a verification of the electronic file is carried out to detect whether or not the electronic file has been falsified.

### BACKGROUND OF THE INVENTION

1. Field of the Invention

The present invention relates to a communication device and a communication method, and in particular, relates to transmission and reception of a document accompanying an assurance of originality.

2. Description of the Related Art

A falsification of time information is prevented in a known time stamp apparatus. For example, when transmitting and receiving an electronic document including a fill-out form, such as an agreement to and from a remote device, a yet-to-be-filled-out electronic document is transmitted to the remote device, and after the fill-out form has been filled out, the electronic document is returned. Therefore, an existence proof and a proof of originality of the electronic document before and after the fill-out are required for a section other than the fill-out form.

### SUMMARY OF THE INVENTION

A preferred aspect of the present invention prevents a falsification and facilitates an assurance of originality of a document in transmission and reception of an electronic file returned after being transmitted to a remote device and edited at a transmission destination.

According to a preferred aspect of the present invention, a communication device transmits and receives an electronic file to and from a remote device. The communication device acquires time stamp data for a prescribed range of the electronic file, and stores the electronic file and the time stamp data by associating the electronic file with the time stamp data. Then, the communication device transmits the electronic file. When the electronic file, which has been transmitted to the remote device, is returned, the communication device verifies the electronic file by using the associated time stamp data.

Preferably, an ID of a time stamp is embedded into the electronic file, and the ID and the time stamp data are stored by being associated.

Preferably, when a verification result is normal, a time stamp is assigned to the electronic file.

The communication device according to a preferred aspect of the present invention assigns a time stamp to a designated range of an electronic file to prevent a falsification of the electronic file, and then transmits and receives the electronic file to and from a remote device. Since the electronic file and the time stamp data are associated, the time stamp data can be detected from the returned electronic file. Accordingly, a verification of the electronic file can be carried out easily. Therefore, even when the electronic file has been falsified by a remote device or the like, the falsification can be detected easily.

Since an ID of a time stamp is embedded in an electronic file, the electronic file and time stamp data can be associated easily. Therefore, when the electronic file is transmitted to a remote device and then returned, originality of the electronic file can be verified. Since the time stamp can be generated by including the ID which has been assigned to the electronic file, a time when the ID has been assigned can be proven and an alteration of the ID can be prevented.

When a verification result of the returned electronic file is normal and the electronic file has not been falsified, a time stamp is assigned to the electronic file. Thus, originality of the entire document can be assured reliably.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a configuration of an Internet facsimile machine and a connection established between the Internet facsimile machine and a time stamp server or the like according to a preferred embodiment of the present invention.

FIG. 2 is a block diagram illustrating a configuration of a document management program of the Internet facsimile machine according to a preferred embodiment of the present invention.

FIG. 3 illustrates a management of an ID or the like according to a preferred embodiment of the present invention.

FIG. 4 illustrates a document management processing according to a preferred embodiment of the present invention.

FIG. 5 illustrates a correspondence between an electronic file and time stamp data according to a preferred embodiment of the present invention.

FIG. 6 is a flowchart illustrating an algorithm when assigning a time stamp to an electronic file and transmitting the electronic file by the Internet facsimile machine according to a preferred embodiment of the present invention.

FIG. 7 is a flowchart illustrating an algorithm when receiving an electronic file by the Internet facsimile machine according to a preferred embodiment of the present invention.

### DETAILED DESCRIPTION OF PREFERRED EMBODIMENTS

A description will be made of preferred embodiments of the present invention.

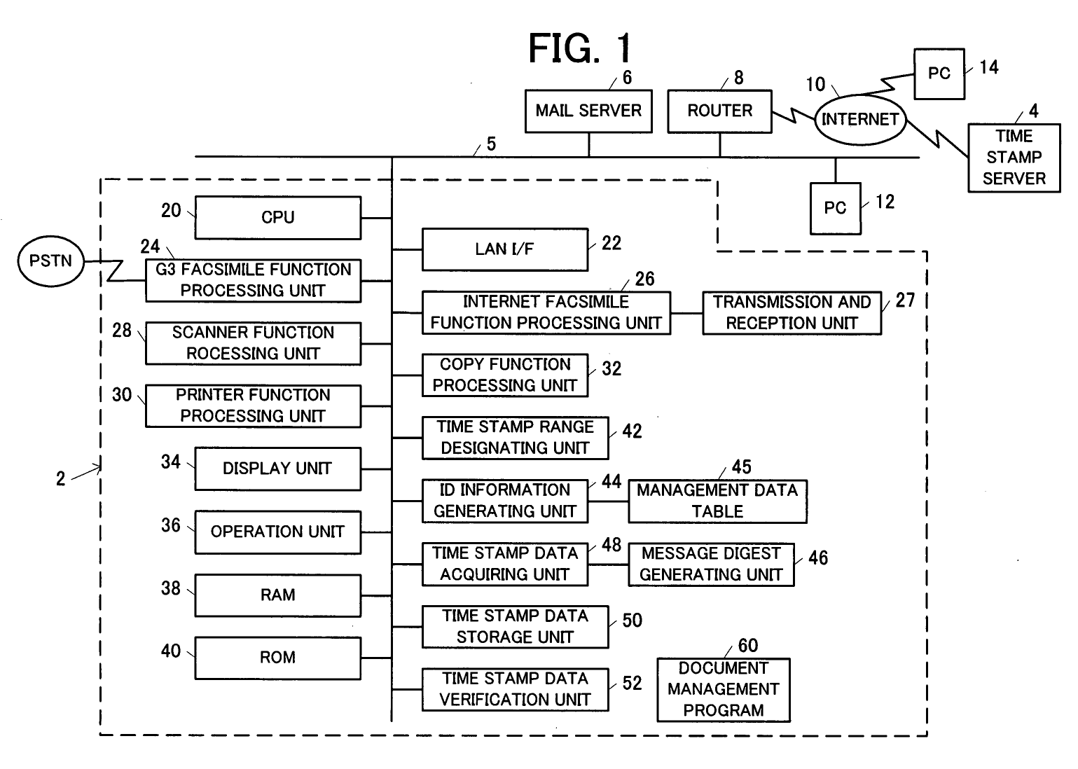

FIG. 1 through FIG. 7 illustrate a preferred embodiment of the present invention. FIG. 1 illustrates a configuration of an Internet facsimile machine 2 as a communication device and a relation with a time stamp server 4 or the like according to a preferred embodiment of the present invention. The Internet facsimile machine 2 establishes a connection with the Internet 10 via a Local Area Network (LAN) 5, a mail server 6 or a router 8 and transmits and receives electronic mail or the like. 12 denotes a communication terminal device, such as a Personal Computer (PC) or the like connected to the LAN 5. A PC 14 is connected via the Internet 10. The PC 14 transmits and receives a document to and from the Internet facsimile machine 2. In the present preferred embodiment, an electronic file is transmitted and received by using the Internet facsimile machine 2. However, the electronic file may be transmitted and received by using the PC 12 or the like.

In FIG. 1, the time stamp server 4 is a server as a third party organization providing a time stamping service. The time stamp server 4 is connected via the Internet 10 to the Internet facsimile machine 2. The time stamp server 4 issues an electronic signature to data from the Internet facsimile machine 2. In the present preferred embodiment, time stamp data of an electronic file is acquired by using the time stamp server 4. However, only standard time information may be acquired from a remote server, and time stamp data of an electronic file may be generated by the Internet facsimile machine 2. Alternatively, without using a remote server, for example, time information may be acquired by using a local server connected to the LAN 5, and the Internet facsimile machine 2 may assign a time stamp by using time information of the Internet facsimile machine 2.

The Internet facsimile machine 2 according to the present preferred embodiment transmits and receives, for example, a document created by the PC 12 or a scanned original document as an electronic file to and from the PC 14 or the like. In the drawing, 20 denotes a Central Processing Unit (CPU) and 22 denotes a LAN interface (LAN I/F). A Group 3 (G3) facsimile function processing unit 24 transmits and receives G3 facsimile or the like via a Public Switched Telephone Network (PSTN). An Internet facsimile function processing unit 26 includes a transmission and reception unit 27 and transmits and receives Internet facsimile in a form of electronic mail, for example. 28 denotes a scanner function processing unit, 30 denotes a printer function processing unit, and 32 denotes a copy function processing unit. 34 denotes a display unit, such as a Liquid Crystal Display (LCD), and 36 denotes an operation unit such as a keyboard or a touch screen.

A Random Access Memory (RAM) 38 stores an electronic file, time stamp data and other data. A Read Only Memory (ROM) 40 stores a program necessary for the Internet facsimile machine 2. In particular, the ROM 40 stores a document management program 60. Further, the document management program 60 is necessary for acquiring time stamp data for a prescribed range of an electronic file, or for storing the electronic file and the time stamp data by associating the electronic file with the time stamp data. Alternatively, the document management program 60 is necessary for assigning a new time stamp to a prescribed range after verifying time stamp data of a returned electronic file.

A time stamp range designating unit 42 accepts a designation of a range to be assigned with a time stamp. A user operates, for example, the operation unit 36 or the PC 12 to designate a range of character data or image data of the electronic file for which the user wishes to acquire time stamp data. An ID information generating unit 44 embeds an ID into the electronic file for which the time stamp data is to be acquired, and manages ID information. By assigning an ID to an electronic file and associating this ID with time stamp data, the ID can be detected from the electronic file and the associated time stamp data can be acquired. The ID information is information, which associates an ID with an electronic file name to be assigned with a time stamp or a range to which the time stamp is to be assigned, for example. The ID information is managed by a management data table 45 or the like. If an ID is assigned to an electronic file, it can be understood that time stamp data is registered with the management data table 45.

A message digest generating unit 46 generates a message digest of a designated range. A time stamp data acquiring unit 48 acquires time stamp data for the generated message digest by a remote server or the like and assigns a time stamp to the message digest. A time stamp data storage unit 50 stores the acquired time stamp data by associating with an ID of an electronic file. A time stamp data verification unit 52 carries out a verification of the time stamp data associated with the electronic file for confirming that the electronic file has not been falsified.

In the present preferred embodiment, the Internet facsimile machine 2 acquires the time stamp data from the time stamp server 4. However, without using the time stamp server 4, the Internet facsimile machine 2 may generate time stamp data for document data. In this case, a standard time information acquiring unit may be provided in place of the time stamp data acquiring unit 48, and only time information may be acquired from a remote server or a server provided in the LAN 5, or the like. Then, the message digest generating unit 46 generates a message digest for the document data and the time information. Alternatively, the Internet facsimile machine 2 uses the time information or the like of the Internet facsimile machine 2 and generates a message digest for the time information. Alternatively, the Internet facsimile machine 2 may easily assign a time stamp by using the Internet facsimile machine 2 or a server in the LAN 5.

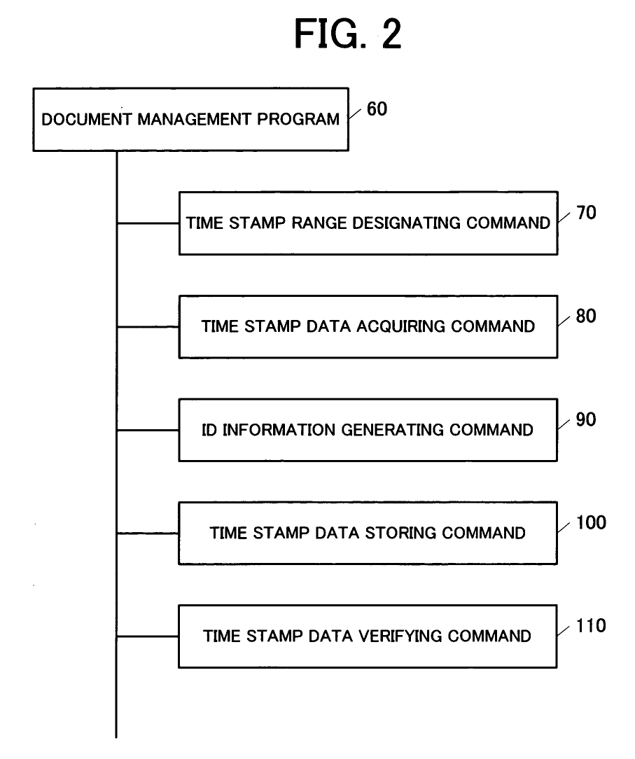

FIG. 2 illustrates an outline of the document management program 60. The Internet facsimile machine 2 stores the document management program 60. The document management program 60 carries out a verification of originality of an electronic file, which has been transmitted to a remote device, edited by the remote device and then returned to the Internet facsimile machine 2. The document management program 60 includes a time stamp range designating command 70, a time stamp data acquiring command 80, an ID information generating command 90, a time stamp data storing command 100 and a time stamp data verifying command 110. The time stamp range designating command 70 is a command for accepting a designation of a range to which a time stamp is to be assigned. The time stamp data acquiring command 80 is a command for generating a message digest corresponding to document data of the designated range and acquiring time stamp data from a remote server or the like. The ID information generating command 90 is a command for embedding an ID into an electronic file. The time stamp data storing command 100 is a command for storing the ID and the time stamp data by associating the ID with the time stamp data. The time stamp data verifying command 110 is a command for verifying the time stamp data associated with the electronic file.

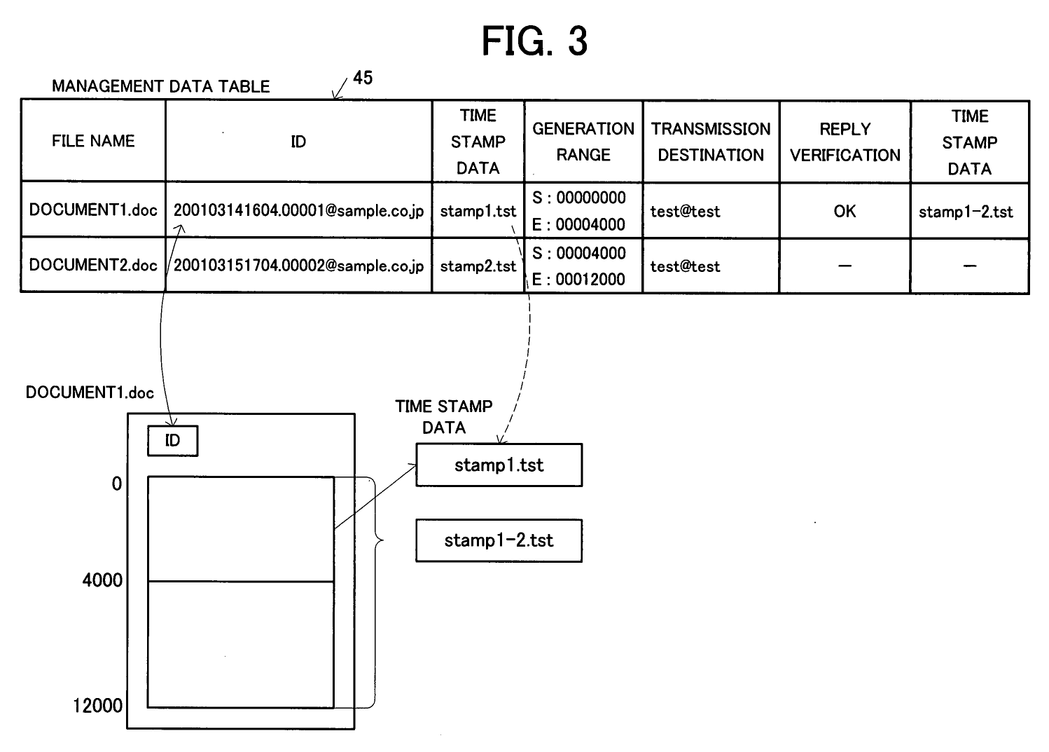

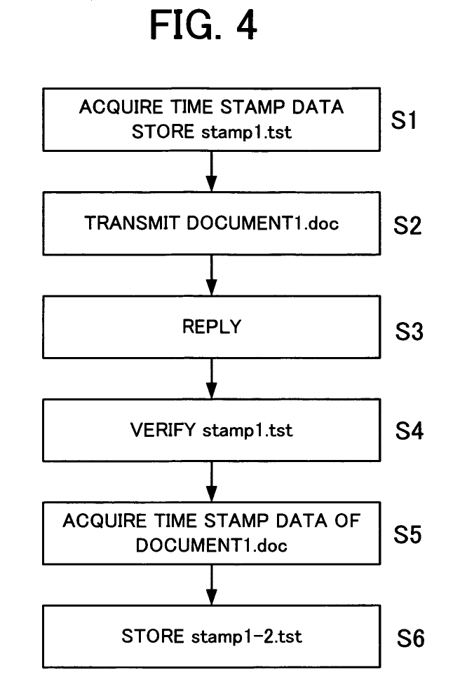

FIG. 3 through FIG. 5 illustrate an example of assigning an ID to an electronic file and managing ID information. In FIG. 3 and FIG. 4, an ID is embedded in a transmission document “DOCUMENT1.doc”. The time stamp data is acquired for a section (data address 0 to 4000) of the document data where falsification is to be prevented. Then, the embedded ID and time stamp data “stamp1.tst” are associated and stored (step S1). That is, the Internet facsimile machine 2 generates a message digest for a range of the data address 0 to 4000, and transmits the generated message digest to the time stamp server 4. The time stamp server 4 assigns an electronic signature regarding this value, a server name, time information or the like and generates time stamp data. Then, the time stamp server 4 returns the generated time stamp data to the Internet facsimile machine 2. The time stamp data acquiring unit 48 acquires the returned time stamp data. The time stamp data and the electronic file are associated and a time stamp is assigned. The management data table 45 registers a file name of a document, an ID of time stamp data, a name of the time stamp data and a generation range or the like by associating one with the other.

When “DOCUMENT1.doc” is transmitted to a remote PC or the like (step S2), a transmission destination edits the document and returns the edited document to the Internet facsimile machine (step S3). Suppose that “DOCUMENT1.doc” is an agreement or the like, and a transmission destination performs an editing work, for example, the transmission destination fills out a date and a signature of a person concerned in the agreement, and then returns the edited agreement. The Internet facsimile machine verifies time stamp data “stamp 1.tst” to confirm that the designated range in the returned “DOCUMENT1.doc” has not been falsified (step S4). The verification is carried out by using the ID embedded in “DOCUMENT1.doc” to acquire the associated time stamp data “stamp1.tst” from the management data table 45 and by comparing a message digest extracted from the time stamp data and a message digest generated for a range of data address 0 to 4000 of the electronic file. As a result of the verification, when the message digests coincide, a confirmation can be made that the electronic file has not been falsified.

If the verification result is correct, a determination is made that the data has not been falsified at the transmission destination. Then, the time stamp data is acquired for the entire document including a signature section signed by the transmission destination (step S5) to prevent the signed document from being falsified. In the drawing, the time stamp data of the entire “DOCUMENT1.doc” (data address 0 to 12000) is stored as “stamp1-2.tst” (step S6). Further, management data of “DOCUMENT2.doc” is also illustrated in the management data table 45 of FIG. 3. The management data table 45 of FIG. 3 indicates that “DOCUMENT2.doc” has not been returned from the transmission destination.

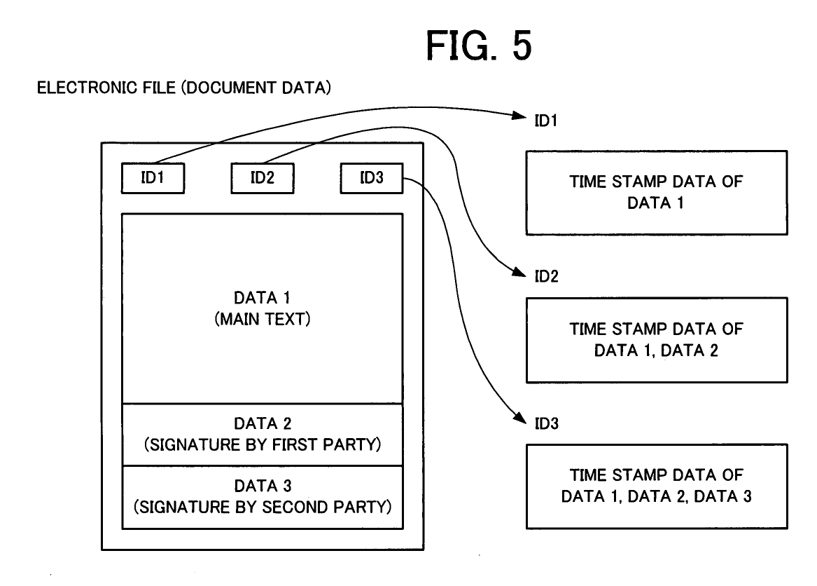

FIG. 5 schematically illustrates an electronic file and time stamp data of the electronic file. Three IDs are assigned to the electronic file illustrated in FIG. 5. It is assumed that ID1 through ID3 have been assigned in order. The ID1 indicates an association of region DATA 1 with respect to time stamp data. The ID2 indicates an association of region DATA 1 and DATA 2 with respect to time stamp data. The ID3 indicates an association of DATA 1 through DATA 3 (entire document) with respect to time stamp data.

For example, when transmitting an agreement, to assign a time stamp to the main text (DATA 1) of the agreement, first, the ID1 is assigned to the electronic file to acquire the time stamp data associated with the main text. Then, the acquired time stamp data is associated with the ID1 and stored. When a person concerned fills out the agreement, for example, by signing the agreement, the associated time stamp data is searched through the ID1 assigned to the electronic file and a verification of the main text (DATA1) is carried out.

After confirming that the main text of the agreement has not been falsified, the ID2 is assigned to the electronic file and time stamp data is acquired for the main text (DATA 1) and the signature column of the person concerned (DATA 2). Then, the DATA 1 and the DATA 2 are stored by being associated by ID2. The verification of the DATA 1 and the DATA 2 can be carried out by acquiring the time stamp data from the ID2.

In the preferred embodiment illustrated in FIG. 5, a time stamp is assigned to the main text and the signature column of the agreement and stored. Next, a signature of another person concerned is requested. After the agreement has been signed by both parties, to prevent the entire document from being falsified, the ID3 is assigned to the document to acquire the time stamp data of the entire document (DATA 1 through DATA 3). The DATA 1 through the DATA 3 are associated with the ID3 and stored.

In the present preferred embodiment, a time stamp is assigned to the main text and the signature columns. However, a time stamp may be generated by including an ID which has been assigned to the electronic file.

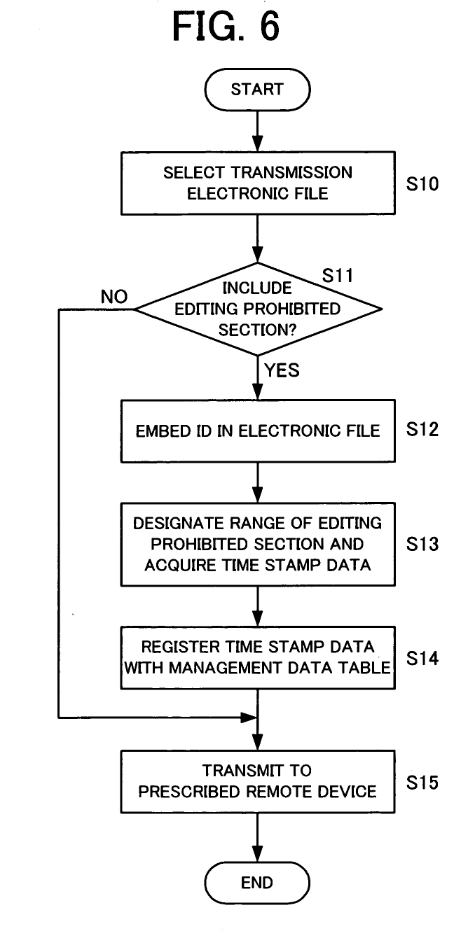

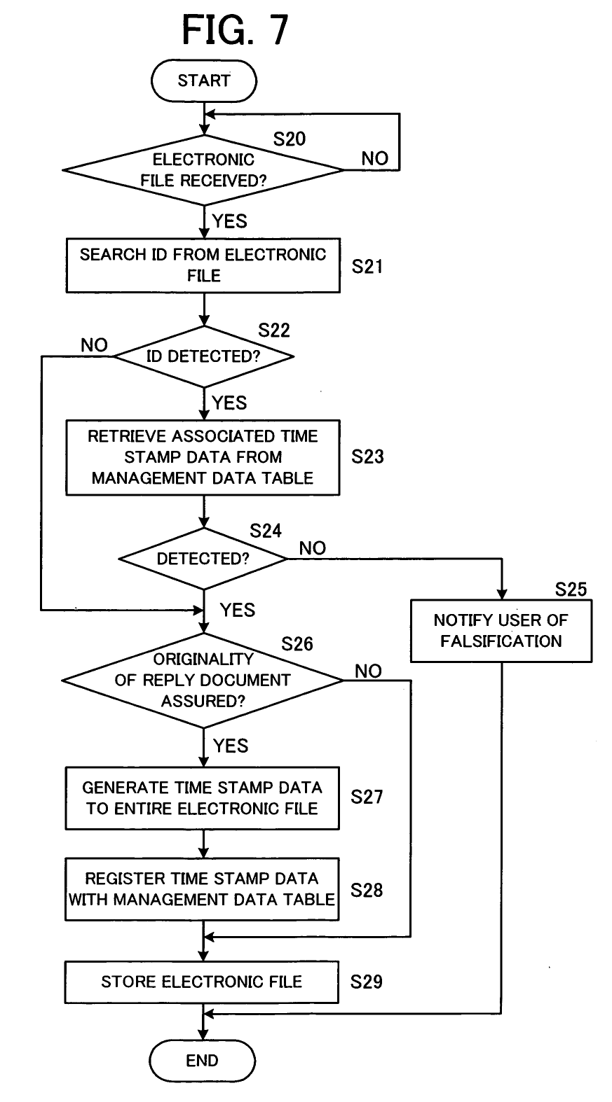

FIG. 6 illustrates a processing at transmission carried out by the Internet facsimile machine. FIG. 7 illustrates a processing at reception carried out by the Internet facsimile machine. First, a transmission electronic file is selected (step S10). If the selected electronic file includes an editing prohibited section (falsification prohibited section), a time stamp is assigned to such an editing prohibited section. An ID for associating the electronic file with the time stamp data is embedded into the electronic file (steps S11, S12). Next, an address or the like of the editing prohibited section is designated, and a message digest for such a section is generated. The generated message digest is transmitted to a remote time stamp server or the like to acquire time stamp data (step S13). After the acquired time stamp data has been associated with ID information and registered with the management data table (step S14), the electronic file is transmitted to a prescribed remote device (step S15). When the remote device receives the electronic file, the remote device fills out the electronic file, for example, signs the electronic file. Then, the remote device returns the electronic file.

In FIG. 7, when the Internet facsimile machine receives an electronic file (step S20), the Internet facsimile machine searches an ID from the electronic file and detects a presence of associated time stamp data (step S21). When the ID has been assigned, the associated time stamp data is acquired from the management data table and a verification is carried out (steps S23, S24). The verification is carried out by comparing the message digest included in the time stamp data and the message digest generated from the editing prohibited section of the electronic file. When the message digests do not coincide, a determination is made that the electronic file has been falsified and a notification is carried out to the user (step S25). Further, when an ID is not detected from the electronic file, in the present preferred embodiment, a determination is made that a time stamp has not been assigned and a verification is not carried out.

Next, when assigning a time stamp to the electronic file and assuring originality of the electronic file, a message digest of document data of the entire electronic file is generated and time stamp data is acquired from a remote time stamp server or the like for the generated message digest (steps S26, S27). Then, the acquired time stamp data is registered with the management data table (step S28), and the electronic file is stored (step S29). When a time stamp assigned by a third party such as a transmission destination has been assigned to the received electronic file, the time stamp is verified and the time stamp data or the like is registered with the management data table.

In the present preferred embodiment, when transmitting an electronic file by the Internet facsimile machine or the like, a time stamp is assigned to a falsification prevented section. The time stamp data is associated by assigning an ID to an electronic file. Therefore, the verification of the time stamp data can be carried out easily. If a document has been filled out in a section other than a fill-out section at a transmission destination, the fill-out can be detected easily. Thus, a document can be transmitted and received without anxiety.

In the present preferred embodiment, a user can designate a range in a transmission document for which the user wishes to acquire time stamp data. Therefore, an important section where the user wishes to prevent falsification can be selected, and such a section can be prevented from being falsified at the transmission destination.

By generating a time stamp by including an ID to be assigned to an electronic file, a time when the ID has been assigned can be proven. Therefore, the ID can be prevented from being altered.

A time stamp can be assigned to the entire document including a section filled out at the transmission destination. Therefore, the originality of the document can be assured easily.

In the present preferred embodiment, a remote server can be requested to assign a time stamp, or only the standard time information can be acquired from the remote server and the Internet facsimile machine itself can assign a time stamp. Accordingly, these modes may be selected and used according to a level of importance or the like of the document. Alternatively, for example, the Internet facsimile machine may assign a time stamp to a part of the document and request a remote time stamp server to assign a time stamp to the entire document.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. A communication device, which transmits and receives an electronic file to and from a remote device, the communication device comprising:
means for acquiring time stamp data for a prescribed range of an electronic file;
means for storing the electronic file and the time stamp data by associating the electronic file with the time stamp data;
means for transmitting the electronic file to the remote device; and
means for receiving the electronic file returned from the remote device and verifying the electronic file by using the associated time stamp data.

2. The communication device according to claim 1, wherein the means for storing the time stamp data embeds an ID of a time stamp into the electronic file and stores the ID and the time stamp data by associating the ID and the time stamp data.

3. The communication device according to claim 1, wherein the means for verifying further assigns a time stamp to the electronic file when a verification result is normal.

4. The communication device according to claim 2, wherein the means for verifying further assigns a time stamp to the electronic file when a verification result is normal.

5. A communication device, which transmits and receives an electronic file to and from a remote device, the communication device comprising:
an acquiring unit which acquires time stamp data for a prescribed range of an electronic file;
a storage unit which stores the electronic file and the time stamp data by associating the electronic file with the time stamp data;
a transmission unit which transmits the electronic file to the remote device; and
a verification unit which receives the electronic file returned from the remote device and verifies the electronic file by using the associated time stamp data.

6. The communication device according to claim 5, wherein the storage unit of the time stamp data embeds an ID of a time stamp into the electronic file and stores the ID and the time stamp data by associating the ID and the time stamp data.

7. The communication device according to claim 5, wherein the verification unit further assigns a time stamp to the electronic file when a verification result is normal.

8. The communication device according to claim 6, wherein the verification unit further assigns a time stamp to the electronic file when a verification result is normal.

9. A communication method for transmitting and receiving an electronic file to and from a remote device, the communication method comprising the steps of:
acquiring time stamp data for a prescribed range of an electronic file;
storing the electronic file and the time stamp data by associating the electronic file with the time stamp data;
transmitting the electronic file to the remote device; and
receiving the electronic file returned from the remote device and verifying the electronic file by using the associated time stamp data.

10. The communication method according to claim 9, wherein at the storing step, an ID of a time stamp is embedded into the electronic file and the ID and the time stamp data are associated and stored.

11. The communication method according to claim 9, wherein at the verifying step, a time stamp is assigned to the electronic file when a verification result is normal.

12. The communication method according to claim 10, wherein at the verifying step, a time stamp is assigned to the electronic file when a verification result is normal.
